(19) United States
(12) Patent Application Publication
(10) Pub. No.: US 2012/0298810 A1
(43) Pub. Date: Nov. 29, 2012

(54) CLAMP FOR SECTION TUBES

(76) Inventors: Deming Chen, Changzhou (CN); Lianping Liu, Changzhou (CN)

(21) Appl. No.: 13/117,136

(22) Filed: May 27, 2011

(51) Int. Cl. F16L 3/08

(52) U.S. Cl. 248/74.1

(57) ABSTRACT

a clamp for section tubes having a shell with a front lateral, a first side having a rear opening defined therein, a second side, a chamber, a tie bar contained in the chamber, and a control screw received in the rear opening in side first side. The chamber has at least one first stage with a slope formed on an inner wall of the first side, at least two second stages respectively with slopes formed on an inner wall of the second side staggering to the first stage, and an open end rear seat formed on the inner wall of the second side. The control screw has a flange sandwiched between the first side and the open end rear seat, an usher tube having an tapering inner surface, a shaft rotatably contained in the open end rear seat, and a camshaft. The tie bar has at least three fingers extending front forward and a rear eccentric opening. Each finger has a hooked head with at least one of the hooked heads curving opposite to the rest hooked heads, and a hook slope.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a clamp for section tubes, and more particularly, to a clamp for production of readily assembled and dismantled framework structure made up with section tubes, in particular for use at fairs and exhibitions.

2. Description of Related Art

With reference to FIGS. 10 and 11, they show a conventional clamping means 9 for inter-connecting more than one profile tubes 8 together to set up a framework structure for use at fairs and exhibitions. The profile tubes 8 has of least four identical side surfaces 81, each having a longitudinal slit 82 defined therein. The clamping means 9 has a shell 90 and at least one latch 92. The shell 90 has at least one longitudinal chamber 91 which is able to slidably receive the latch 92. The latch 92 has a cover containing a hooked lever 93 which is able to be pulled by a screw 94. The screw 94 is able to be buttoned down. In assembly, a user is able to press down the screw 94 and then insert the latch 92 into the chamber 91. When the screw 94 passes a through hole 95 defined in the shell 90, it upsprings and is matchingly received in the hole 95, thus making the latch 92 stably fixed with respect to the shell 90. The shell 90 may have a pair of opposite side guiding grooves 96 matching a pair of opposite guiding bars 83. When the shell 90 is inserted into the profile tube 8 as particularly shown in FIG. 11, it is able to be fixed there with several screws 84. A screw lever 85 can be used to access the screw 94 via an opening 86 defined in the side surfaces 81. The screw 94 can be tightened or loosened to control the hooked lever 93 to lock or release another profile tube 8 (not shown). In order to facilitate the access of the screw lever 85, an usher tube 97 has to be provided mounting between a pair of parallel rails 98.

Such kind of clamping means has some shortcomings. First, in assembly, a user has to press down the screw 94 against a very tough spring in the latch 92 before he can insert the latch 92 into the chamber 91. It is extremely painstaking especially when repeated hundreds or even thousands times in one production of an exhibition framework. Second, a diameter of the through hole 95 must be tightly fitted to that of the screw 94 to prevent movement of the screw 94 within the through hole 95 after the screw 94 upsprings. However this significantly increase the difficulty of insertion of the latch 92 since it always takes the user time to align the screw 94 with the through hole 95, besides the latch 92 is very hardly to fine adjust after insertion into the chamber 91. Third, for a certain predetermined width of the clamping means 9, a width of hooked lever 93 has to be small since the clamping means 9 needs to accommodate the latch 92 having a latch shell 99 thereof. The small width will decrease the strength of the hooked lever 93. To resolve this problem, usually two latches 92 are provided, as shown in FIG. 10. However, this will further increase, the assembly workload of the latch 92. Fourth, the mounting and aligning the usher tubes 97 to the screws 94 also take a long unnecessary time

### BRIEF SUMMARY OF THE INVENTION

The main object of the invention is to provide a clamp for section tubes which does not need to press down a screw in assembly, thus having a much lower workload for a user.

Another object of the invention is to provide a clamp for section tubes which does not need to align the screw with an through hole in assembly, thus having a lower workload for a user.

Still another object of the invention is to provide a clamp for section tubes which is able to have a greater width of a hooked lever for the clamp for use with a predetermined certain width of, a section tube.

Yet another object of the invention is to provide a clamp for section tubes which does not need to separately mount and align an usher tube in assembly, thus having a much lower workload for a user.

In order to realize above objects, the invention provides a clamp for section tubes having a shell with a pair of opposite lateral, a front lateral, a rear lateral, a first side having a rear opening defined therein, a second side, a chamber, a tie bar contained in the chamber, and a control screw received in the rear opening in side first side. The chamber has at least one first stage with a slope formed on an inner wall of the first side, at least two second stages respectively with slopes formed on an inner wall of the second side staggering to the first stage, and an open end rear seat formed on the inner wall of the second side. The control screw has a flange sandwiched between the first side and the open end rear seat, an usher tube having an tapering inner surface, a shaft, rotatably contained in the open end rear seat, and a camshaft. The tie bar has at least three fingers extending front forward and a rear eccentric opening. Each finger has a hooked head with at least one of the hooked heads curving opposite to the rest hooked heads, and a hook slope.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is an exploded perspective view of the preferred embodiment of a clamp and a section tube.

FIG. 2 is a flat cross-sectional view showing an inter-connecting operation of the clamp.

FIG. 3 is an exploded perspective view of the clamp.

FIGS. 4 and 5 are bottom and perspective views of a control screw, respectively.

FIG. 6 is a flat side view of a shell of the clamp.

FIG. 7 is a cross-sectional view of the shell of the clamp from the direction of A-A shown in FIG. 6,

FIGS. 8a through 8d are a partial flat views showing an operation of the control screw and a tie bar of the clamp.

FIG. 9 is an exploded perspective view of another embodiment of the clamp.

FIG. 10 is a perspective exploded view of a conventional clamping means and the profile tube. And,

FIG. 11 is a cross-sectional view of the conventional clamping means and the profile tube shown in FIG. 10.

### DETAILED DESCRIPTION OF THE INVENTION

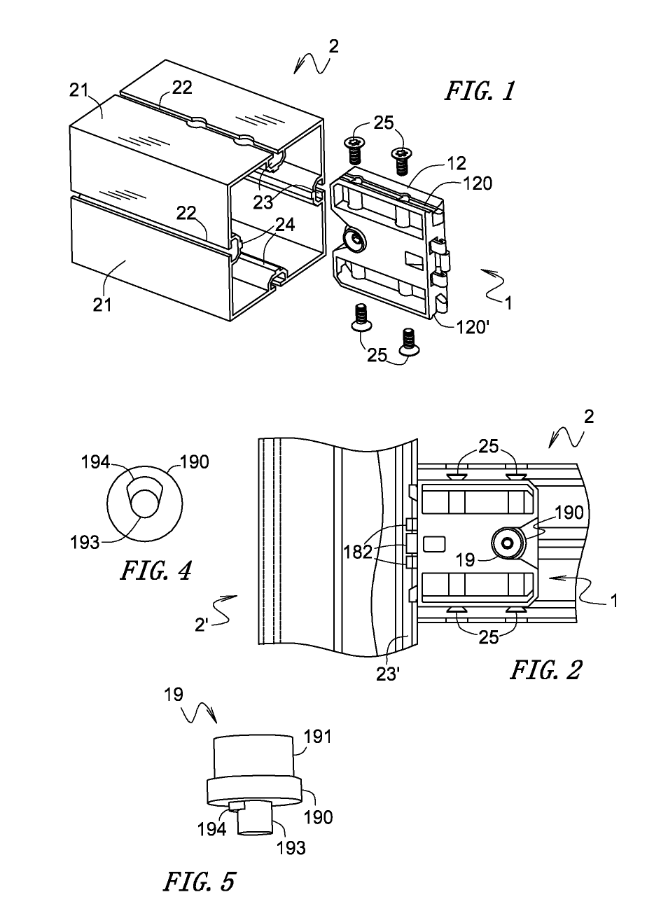

Shown in FIGS. 1 and 2 are the preferred embodiment of a clamp 1 and section tubes 2 of the invention. The section tube 2 has at least four identical side surfaces 21, each having a longitudinal slit 22 defined therein. Beneath each slit 22 there is an inwards recess 23 and along each inwards recess 23 there is a longitudinal guiding bar 24. As particularly shown in FIG. 2, the clamp 1 is able to be inserted into the section tube 2 with a pair of opposite guiding groove 120, 120′ slidably covering on two opposite guiding bar 24. The clamp 1 is able to be securely fixed with respect to the section tube 2 with a plurality, usually four, screws 25. When the clamp 1 is fixed, hooked heads 182 of, a tie bar (not shown in this Fig.) stick out of, an end of one section tube 2 and are able to be inserted into one inwards recess 23′ of another section tube 2′ from a free end of the another section tube 2′. When a user rotates a control screw 19 with a screw driver (not shown), the hooked heads 182 move inwards the clamp 1 thus inter-locking the another section tube 2′ with the section tube 2. A reverse rotation of the control screw 19 may drive the hooked heads 182 outwards the clamp 1, making the another section tube 2′ released.

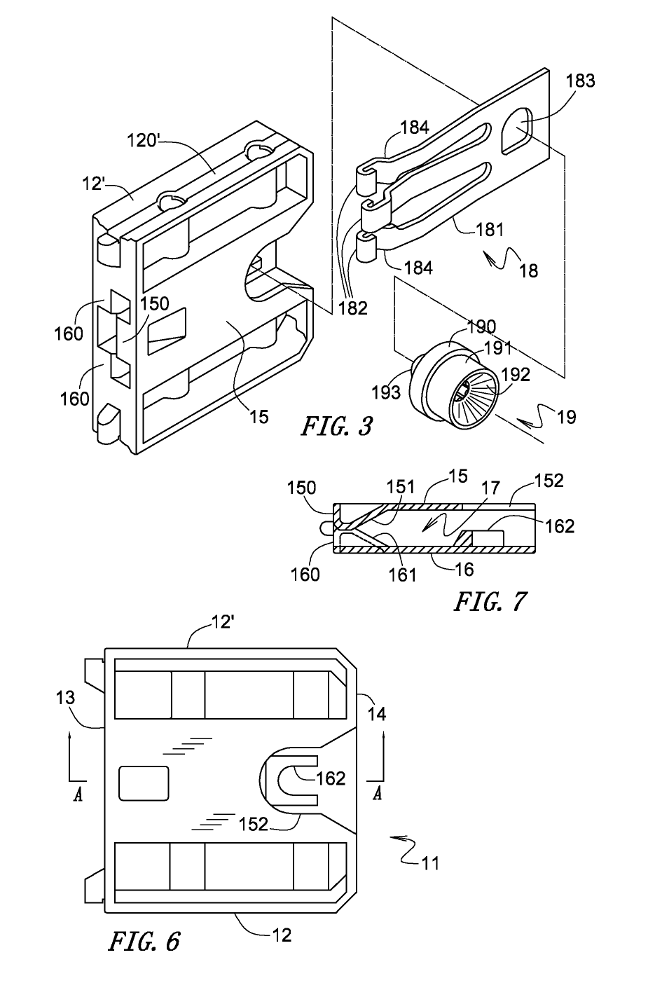

With reference to FIGS. 3 to 7, the clamp 1 of the invention has a shell 11 with a pair of opposite lateral 12, 12′, a front lateral 13, a rear lateral 14, a first side 15, and a second side 16. Each of the opposite lateral 12 or 12′ has a guiding groove 120 or 120′ defined therein. The shell 11 has a chamber 17 containing a tie bar 18 therein. At least one first stage 150 with a slope 151 is formed on an inner wall of the first side 15 in the chamber 17 and at least two second stages 160 respectively with slopes 161 opposite and staggering to the first stage 150 are formed on an inner wall of the second side 16 in the chamber 17. A rear opening 152 is defined in the first side 15 for receiving the control screw 19. An open end rear seat 162 is formed on the inner wall of the second side 16. The control screw 19 has a flange 190 being able to be sandwiched between the first side 15 and the open end rear seat 162 on the second side 16, an usher tube 191 having a tapering inner surface 192 for facilitating an access of a screw driver to the control screw 19, a shaft 193 for fixing the control screw 19 with respect to the shell 11, and a camshaft 194 for driving the tie bar 18. The tie bar 18 has at least three fingers 181 extending front forward and a rear eccentric opening 183. Each finger 181 has a hooked head 182 and at least one of the hooked heads 182 curves to an opposite direction to the rest hooked heads. A hook slope 184 is defined in a vicinity of each hooked head 182. The open end seat 162 is for rotatably receiving the shaft 193 of the control screw 19.

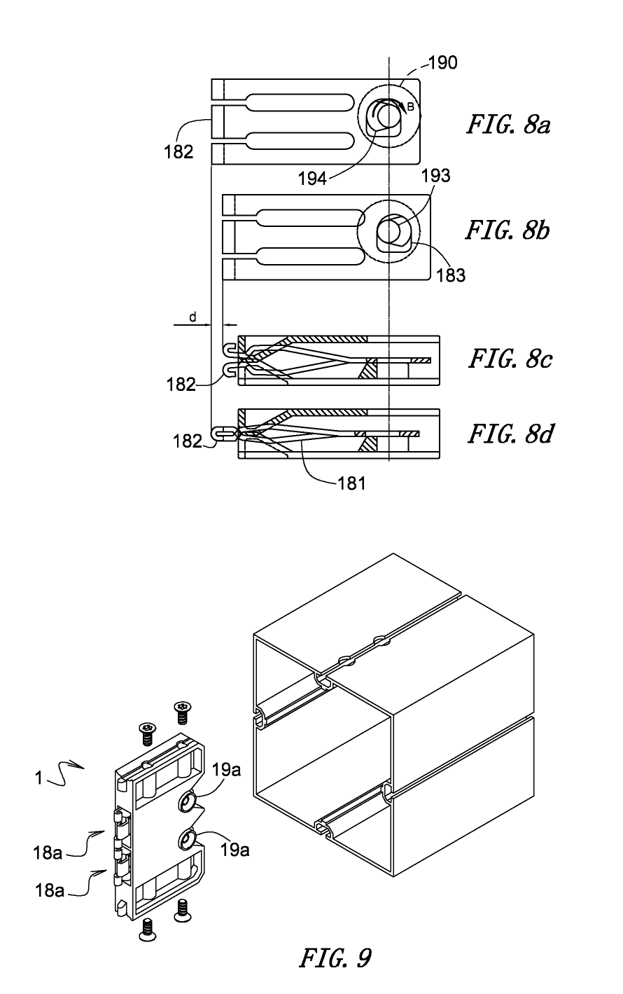

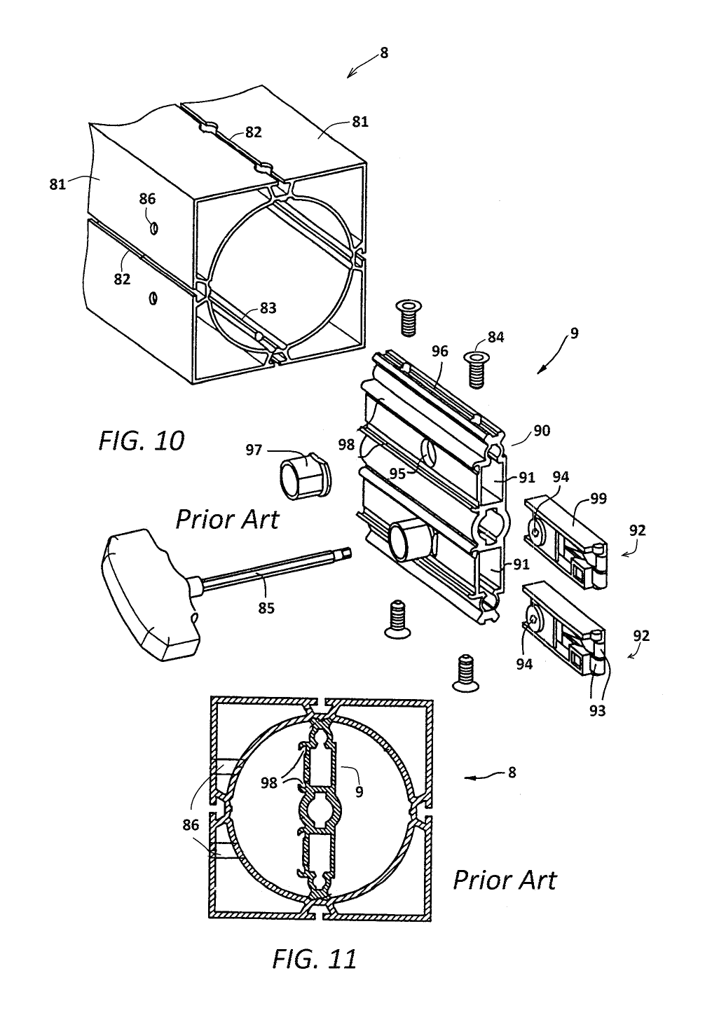

FIGS. 8a through 8d show an operation of the control screw 19 and the tie bar 18. FIGS. 8a and 8d show a spare status of the clamp 1 in which the camshaft 194 faces forward. In use, the user is able to rotate the control screw 19 in direction B with a screw driver. The shaft 193 then rotates within the seat 162. As shown in FIGS. 8b and 8c, after a rotation of about 180 degree, the camshaft 194 drives the tie bar 18 to move rearward a distance “d”. In this process, the hook slopes 184 pass by the first and the second stages 150 and 160, and the fingers 181 will be pushed by the stages 150, 160 to a direction in which each hooked head 182 curves. At last, the hooked heads 182 will lock the another section tube 2′, as shown in FIG. 2.

Shown in FIG. 9 is another embodiment of the clamp 1a of the invention. All the structures are the same as the preferred embodiment except for there are two side by side tie bars 18a with two control crews 19a thereof and two seats for the two control screws 19a provided in the chamber.

From above description. it could be seen that the control screw 19 of the invention is pre assembled in the clamp 1 and does not need to be pressed down or to align with a through hole on site of production of section tube framework. Second, without the provision of the latch shell, for a predetermined size of a section tube, there could be more room for a wider tie bar, and hooked heads. The strength of the tie bar is increased. Third, a control screw 19 with an integral usher tube 191 having a tapering inner surface 192 saves the time for mounting and aligning the conventional separate usher tubes.

From above description, it is seen that the objects of the present invention have been fully and effectively accomplished. Embodiment of the invention has been shown and described for the purposes of illustrating the functional and structural principles of the present invention and is subject to change without departure from the, invention's principles. Therefore, this invention includes all modifications encompassed within the spirit and scope of the following claims.

What is claimed is:

1. A clamp for section tubes comprising a shell with a pair of opposite lateral sides, a front side, a rear side, a first side having a rear opening defined therein, a second side, a chamber, a tie bar contained in said chamber, and a control screw received in said rear opening in side first side; said chamber having at least one first stage with a slope formed on an inner wall of said first side, at least two second stages respectively with slopes formed on an inner wall of said second side staggering to said first stage, and an open end rear seat formed on said inner wall of said second side; said control screw having a flange sandwiched between said first side and said open end rear seat, an usher tube having a tapering inner surface, a shaft rotatably contained in said open end rear seat, and a camshaft; and said tie bar having at least three fingers extending front forward and a rear eccentric opening, each said finger having a hooked head with at least one of said hooked heads curving opposite to the rest hooked heads and a hook slope.
